(19) United States
(12) Patent Application Publication
(10) Pub. No.: US 2026/0055281 A1
(43) Pub. Date: Feb. 26, 2026

(54) ANTIBACTERIAL WATER-BASED PAINT THAT IS ACTIVATED BY METALLIC NANOPARTICLES

(71) Applicants: FACULTY OF SCIENCES OF SFAX, SFAX (TN); Fluoink Nanotechnologies, Sfax (TN)

(72) Inventors: Hanen DOUIRI, Sfax (TN); Marwa ABID, Sfax (TN); Ramzi MAALEJ, Sfax (TN)

(73) Assignee: Fluoink Nanotechnologies, Sfax (TN)

(21) Appl. No.: 18/974,370

(22) PCT Filed: May 30, 2023
(86) PCT No.: PCT/IB2023/055534

§ 371 Date: Nov. 12, 2025

(30) Foreign Application Priority Data
Jun. 9, 2022 (TN) TN2022/0157

(51) Int. Cl. C09D 7/61; C09D 5/02; C09D 5/14; C09D 7/20; C09D 7/40

(52) U.S. Cl. CPC C09D 7/61; C09D 5/022; C09D 5/025; C09D 5/027; C09D 5/14; C09D 7/20; C09D 7/67

(57) ABSTRACT

An antibacterial paint composed of a water-based paint functionalized by metallic nanoparticles that is used on wall supports to target bacteria, pathogenic strains, and nosocomial infections. Metallic silver (Ag) nanoparticles with average diameters of 83 nm synthesized by an aqueous method using PVA and an aqueous solution of silver ion. The water-based paint was created with a weight of titanium dioxide ranging between 7 and 12%, a weight of filler ranging between 25 and 35%, a weight of emulsion binder ranging between 30 and 40%, a weight of water ranging between 15 and 20%, a weight of dispersing agent ranging between 0.3 and 0.5%, a weight of silicone antifoam agent ranging between 0.15 and 0.3%, and a pH value ranging between 7.5 and 8.

### 1. TECHNICAL FIELD

The invention relates to the creation and production of an antimicrobial paint that is strengthened by the inclusion of additives into water-based paints. This paint, in particular, has a greater trapping and neutralization rate of pathogenic bacteria, notably nosocomial germs, when applied to large-surface supports than standard paints.

### 2. LITERATURE

With the discovery of antibiotics, mainly Penicillin, mankind has had a means and an extremely effective remedy against the scourges of pathogenic bacteria that have plagued it for millennia. These pathogenic microorganisms are also thought to be health concerns, increasing the death rate of patients in hospitals or clinics. These people are plainly exposed to nosocomial infections that are resistant to antibiotics during a hospital stay, surgical treatment, or the usage of medical implants. According to the World Health Organization (WHO), 1.4 million people have developed an infection while visiting a hospital (OMS Report, 2014). This same body has recently stressed the significance of enhancing anti-infectious-disease procedures (OMS Report, 2021). However, the extensive and unrestricted use of antibiotics in medicine over the last two decades has resulted in the creation of a frightening condition that is becoming worse by the day. This is the phenomenon of pathogenic bacteria resistant to commonly used antibiotics. Indeed, there are strains of Staphylococcus aureus and Pseudomonas aeruginosa that are resistant to all known antibiotics (L. Yuwen, et al, MoS 2@ polydopamine-Ag nanosheets with enhanced antibacterial activity for effective treatment of Staphylococcus aureus biofilms and wound infection, Nanoscale, Volume 10, Issue 3, Pages 16711-16720, 2018.).

The approaches used to overcome the resistance of pathogenic bacteria, particularly nosocomial infections, are few and far between. The most traditional option relied on the use of other antibiotics due to their speed and efficacy. However, the prolonged exposure of these bacteria to antibiotics has increased their resistance even more. Furthermore, when they grow in favorable environments, these bacteria have the ability to produce a protective layer known as “biofilm.” Furthermore, these biofilm-associated bacteria are extremely difficult to eradicate.

In fact, these bacteria's ability to sequester a polysaccharide matrix makes the access of antibiotics almost difficult. As a result, bacterial resistance to antibiotics is a major health concern, explaining the lack of effective antibiotic agents. A second approach is based on therapeutic treatments. The most intriguing avenue is the use of inhibitors, namely molecules that obstruct bacterial enzymes capable of destroying antibiotics. This alternative is in the development stage or is being evaluated in the context of clinical trials. Parallel to this stage, rational antibiotic prescribing measures are now in place to reduce the emergence of resistance.

An important alternative in the battle against nosocomial infections is prevention through stringent hygiene measures to enhance the asepsis of medical devices or limit the carrying of germs by caregivers or patients. Thus, worldwide recommendations coordinated by the WHO in 2021 seek to generate specific measures for each institution and patient, which are subsequently communicated in hospital departments by operational hygiene teams. Before any invasive operation, the care protocol requires: (i) hand washing with hydro-alcoholic solutions, (ii) disinfection of the patient's skin, and (iii) disinfection and/or sterilization of the equipment utilized (Report of the WHO, 2021). These proposals remain difficult to implement due to the lack of bravery and noncompliance of many stakeholders in extremely demanding working conditions.

Following technological advancement, nanotechnology is regarded as one of the most promising and successful methods of treating bacterial infections. Advanced and innovative progress in the field of nanotechnology, particularly the development of technologies and processes for the synthesis of nanoparticles (NPs) with specified properties, are anticipated to lead to the creation of appropriate antibacterial agents. Nanoparticles have long been used in paint applications due to their high surface-to-volume ratio (Mohammad J. Hajipour, et al, Antibacterial properties of nanoparticles, Trends in Biotechnology, Volume 30, Issue 10, 2012, Pages 499-511) and unique properties (Jeevanandam et al., Review on nanoparticles and nanostructured materials: history, sources, toxicity and regulations, Beilstein Journal of Nanotechnology, Volume 9, Pages 1050-1074, 2018). Interacting with the bacterial cell barrier and suppressing bacterial protein and DNA production are essential and encouraging qualities for the utilization of this research and development field. Furthermore, while metallic nanoparticles are well known for their antibacterial toxicity, identifying the optimum nanoparticle for biomedical applications with a high antibacterial activity is a difficult task. Among these nanoparticles, are ones made of silver (Ag). This material derives its antimicrobial activity from the ability of silver ions to bind irreversibly to a variety of nucleophilic groups commonly present in the cells of bacteria, viruses, yeasts, fungi, and protozoa. Binding to cellular components disrupts the natural cycle of reproduction and growth, resulting in cell death. The form of the Ag nanoparticles is decisive for this application, namely the triangle shape which has the most effective shape for enhanced antibacterial activity (Vo et al., Controlled synthesis of triangular silver nanoplates by gelatin-chitosan mixture and the influence of their shape on antibacterial activity, Processes, Volume 7, Issue 12, Page 873, 2019). Taking advantage of its potent action, silver and its compounds have been included throughout the years into a wide range of wound care products such as dressings, hydrogels, hydro-colloids, creams, gels, lotions, catheters, sutures, and bandages. A technology to produce large-area carriers containing these Ag nanoparticles for antibacterial application in hospitals and operating rooms is considered innovative and in high demand in the market. Obtaining Ag nanoparticles in huge quantities and at a reasonable cost is technologically a very rare quality. Ag's size and shape are two determining factors in ensuring antibacterial activity.

All of the approaches available to ensure the synthesis of these nanoparticles are based on the aqueous pathway, with surfactants and organic stabilizers being used. However, these technologies will continue to be a rather complicated step with extremely high costs and very poor production and antibacterial activity. Other are being designed to improve the properties of this aqueous method, including the selection of surfactants and stabilizers, Ag growth time, solvent types, and the selection of textile and polymer-based supports. Given these techniques, a technology transfer for manufacturers must meet the requirements of the mass production of Ag nanoparticles and their functionalization on broad support surfaces, thus ensuring adherence with strong antibacterial activity at very cheap costs.

The US patent (U.S. Pat. No. 9,888,691B2) details the production of Ag nanoparticles using a volume ratio of 35% of water and miscible alcohol solvents. A salt-based powder is used as the silver precursor. Lower alcohols with straight (C1-C6) or branched chain, such as acetone, tetrahydrofuran, formamide, dimethylformamide, and acetamide, are miscible organic solvents. Triethanolamine and N,N,N′,N′ tetramethylethylene diamine were chosen as reducing agents (TEMED). Polysorbates are used as a surfactant to avoid nanoparticle agglomeration. Finally, an amide-based stabilizer, substituted amides, and a primary nitrogen are chosen to ensure Ag stability. This method requires synthesis temperatures ranging from 60 to 120° C. for 4 hours, depending on the nature of the surfactants and stabilizers, as well as a rather long stabilization phase ranging from 3 to 7 days under light.

The Canadian patent (CA2,949,664A1) presents an antibacterial use of Ag nanoparticles in the form of varnish applied on polymer surfaces such as thermoplastics, resins, and carbon fiber-doped polymers. The production of Ag nanoparticles is a chemical procedure known as “bottom up,” which produces nanoparticles ranging in size from 20 nm to 400 nm from silver powder while using high temperatures [100-140° C.] and applying laser light. These silver nanoparticles are then functionalized with silicon oxide SiO₂ in the form of varnishes with stabilizers and reducing agents before being applied to polymer surfaces as antimicrobial carriers. The antibacterial reactivity of these nanoparticles is highly dependent on the type of support employed. A concentration of at least one part per million (1 ppm) of silver-containing nanoparticles is recommended to achieve antibacterial activities. Tests show that concentrations beyond 100 ppm have no effect on the antibacterial properties of the resultant substance. If silver nanoparticles are introduced with solid additives, the suggested concentration of silver nanoparticles is between 2 ppm and 50 ppm (i.e. between 2 and 5 g/l) to obtain satisfactory antibacterial properties. As for liquid additives, the recommended concentration of silver nanoparticles is between 3 and 15 g/l.

The above-mentioned innovations disclose methods for synthesizing and functionalizing silver nanoparticles for use in antibacterial healthcare applications. However, these manufacturing processes require high levels of control and precision, such as (namely) high temperatures, which require external energy and thus increase production costs, development and stabilization times of up to 7 days, limited choice of stabilizers and reducers which necessitates the use of very expensive control tools, and finally a low rate of material production which makes these techniques unsuitable for the industrial and mass production (requirements of these materials).

The current invention is a paint having antibacterial properties. Indeed, silver nanoparticle-based additives are incorporated into the paints, offering antibacterial qualities. This paint has a strong antibacterial reactivity and destroys pathogenic germs, particularly nosocomial bacteria, when applied to broad surfaces. These additive materials are created utilizing aqueous synthesis procedures and technologies.

### SUMMARY

In one aspect of the present invention, the invention provides an aqueous silver nanoparticle composition, comprising silver nanoparticles sizes of 50-110 nm, polyvinyl alcohol, and water. In another aspect the invention, the silver nanoparticle having a UV-visible absorption peak at about 430 nm.

In a further aspect of the invention, the silver nanoparticle is produced by mixing and heating ionic silver (Ag⁺) stock solution with a polyvinyl alcohol stock solution. In a particular embodiment of the invention, the ionic silver (Ag⁺) is silver nitrate. In a particular embodiment of the invention, the silver nitrate stock solution at about 6-10 nM. In a particular embodiment of the invention, the polyvinyl alcohol having molecular weight of about 89-98 kDa. In a particular embodiment of the invention, the polyvinyl alcohol stock solution is a about 1-3.5%. In a particular embodiment of the invention, the heating is at about 70-120° C.

Another aspect of the present invention provides a method of making the aqueous silver nanoparticle composition, characterized by the steps of: preparing a clear stock polyvinyl alcohol solution in water: preparing an ionic silver (Ag⁺) solution: incorporating the ionic silver (Ag⁺) solution with the polyvinyl alcohol solution; and heating the polyvinyl alcohol and ionic silver (Ag⁺) solution. In a particular embodiment of the invention, the ionic silver 20 (Ag⁺) solution is silver nitrate. In a particular embodiment of the invention, the ionic silver (Ag⁺) solution is about 6-10 nM. In a particular embodiment of the invention, the polyvinyl alcohol having a molecular weight of 89-98 kDa. In a particular embodiment of the invention, the polyvinyl alcohol solution is about 1-3.5% w/v. In a particular embodiment of the invention, the heating is at about 70-120° C.

A further aspect of the invention provides a water-based paint, comprising: an aqueous silver nanoparticle composition according claims 1-8: a titanium dioxide weight ranging between 7 and 12%: a filler weight ranging between 25 and 35%: an emulsion binder weight ranging between 30 and 40%: water weight ranging between 15 and 20%: a dispersing agent weight ranging between 0.3 and 0.5%; and a pH value ranging between 7.5 and 8. In a particular embodiment of the invention, the aqueous silver nanoparticle composition is 500-2,500 ppm. In a particular embodiment of the invention, the water based paint further comprising a silicone antifoam agent weight ranging between 0.15 and 0.3%.

### BRIEF DESCRIPTION OF FIGURES

The foregoing summary, as well as the following detailed description of the preferred embodiments, will be better understood when read in conjunction with the appended drawings. It should be understood, however, that the invention is not limited to the precise arrangements and instrumentalities shown. In the drawings,

FIG. 1 shows DLS data plot of aqueous-synthesized silver (Ag) nanoparticles according to an embodiment of the invention;

FIG. 2 illustrates the UV-visible absorption spectrum of silver (Ag) nanoparticles according to an embodiment of the invention; and

FIG. 3 shows the FTIR spectrum of silver (Ag) nanoparticles according to an embodiment of the invention.

### DETAILED DESCRIPTION OF THE INVENTION

The present invention relates first to a method of the optimization of the parameters of the synthesis of metallic silver (Ag) nanoparticles and also to the incorporation as additives in a water-based antibacterial paint.

The present invention comprises the following aspects:
A. The present invention involves the optimization of the technique for aqueous synthesis of silver (Ag) nanoparticles coated with a polyvinyl alcohol (PVA) polymer. Several experimental factors, namely the type of the solvents, temperature, and silver ion concentrations, have been optimized. Table 1 in Example 1 show their effects on the size and spectroscopic properties.
B. The present invention also relates to optimizing the protocol for the production of the water-based paint as well as the incorporation of the silver nanoparticle-based additive in this paint. The water-based paint is created by combining polymeric ingredients which provide optimal pigment dispersion and stability. The Ag-PVA solution was used as an additive to give the water-based paint an antibacterial characteristic. As well, other defamers and coalescing agents have also been used to improve viscosity and spread of the paint with a higher gloss, ensuring an aesthetically pleasing finish. Example 2 goes over the aforementioned features in further depth.
C. The present invention further relates to improving the antibacterial activity of the water-based paint containing silver nanoparticles. To assess their screening for the inhibitory impact, the Ag nanoparticles were evaluated alone for antibacterial activity using the agar well diffusion (AWD) method in the first investigation. Deep growth inhibition tests utilizing Luria-Bertani (LB) Agar—were performed to examine potential interferences from enriched culture media. The same inhibitory conditions were used to test the antibacterial properties of water-based paint films containing Ag metal nanoparticle additives. In Example 3, the antibacterial characteristics were examined and determined in Tables 2 and 3.

### EXAMPLES

The following examples will demonstrate preferred embodiments of the current invention, which should not be interpreted as restricting the invention's potential.

The invention provides an antibacterial water-based paint functionalized by metallic nanoparticles by including the following preceding steps:

### Example 1: Aqueous Synthesis of Silver (Ag) Nanoparticles Coated with PVA

This example provides one embodiment of the optimization of the synthesis of silver (Ag) nanoparticles coated with a polyvinyl alcohol (PVA) polymer, as well as their morphological and spectroscopic characterizations and antibacterial activity.

### *Synthesis of Ag-PVA Stock Solutions

The synthesis of metallic nanoparticles typically necessitates the addition of a stabilizing agent, such as a surfactant or a polymer to coat the nanoparticles. In this particular example, weight of PVA of 0.4-0.7 g, preferably 0.5 g, was dissolved in 20-40 ml, preferably 25 ml of hot deionized water while vigorously stirred. Typically, the polyvinyl alcohol having molecular weight of about 89-98 kDa. This process is carried out to produce a colorless, clear PVA solution. To initiate the Ag⁺→Ag reaction, an aqueous solution of silver nitrate with molar concentration of 6-10 mM, preferably 8 nM, and a volume in the range of 200-350 ml was prepared and added to the PVA solution. The combination was held at 70-120° C. for roughly 1-3 hours until the color of the suspension changed to light yellow, indicating that it was in an equilibrium condition.

The sample was cooled to 20-25° C. in order to maintain a stable Ag-PVA colloidal solution. During this step, the influence of several factors such as PVA mass, water volume, silver concentration, boiling temperature and time, and cooling temperature was determined (Table 1).

TABLE 1
Conditions and parameters for the synthesis of Ag-
PVA nanoparticles by the solution chemistry method.

| Mass of PVA | 0.5 | g |
|---|---|---|
| Volume of deionized water | 25 | ml |
| Silver concentration/volume | 8 mM/250 ml | |
| Heating temperature | 90° | C. |
| Heating time | 2 | hours |
| Cooling temperature | 20-25° | C. |

### *Ag-PVA Nanoparticle Size Analysis

The dynamic light scattering (DLS) method used to analyze the size of the Ag-PVA nanoparticles (FIG. 1) revealed that these nanoparticles have consistent diameters in the range of [50-110 nm]. To analyze the size distribution of the nanoparticles, the sample solution was diluted with deionized water to extract all individual nanoparticles from the aggregates.

### *Optical Analysis of Ag-PVA Nanoparticles

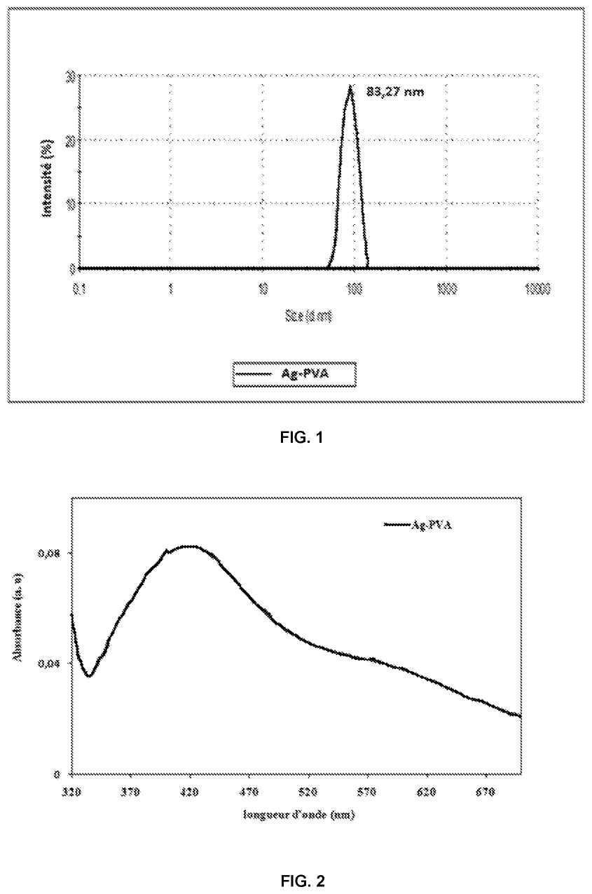

The UV-visible absorption method was used to examine the absorbance of Ag-PVA nanoparticles as a function of wavelength (FIG. 2). The UV-visible absorption spectrum was obtained with a resolution of 2 nm and a wavelength range of 200 to 800 nm. In addition, the spectrum reveals a band centered at 430 nm, emphasizing the creation of Ag-PVA nanoparticles with a triangle shape morphology, which is necessary for the antibacterial use.

### *Spectroscopic Analysis of Ag-PVA Nanoparticles

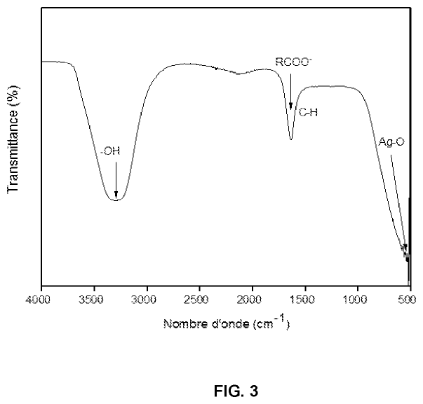

Fourier transform infrared spectroscopy (FTIR) vibrational analysis was utilized to demonstrate the presence of Ag silver ions functionalized by PVA. In the 500-4000 cm⁻¹ range, the FTIR spectrum is obtained in absorbance mode and at normal incidence (FIG. 3). This measurement reveals an absorption band centered at 520 cm⁻¹, demonstrating the silver (Ag) nanoparticles' crystalline structure. This study also revealed the presence of —OH hydroxyl groups in the Ag-PVA nanoparticles' 3300 cm⁻¹ band. A vibration band centered at 1680 cm⁻¹ was also found, which is linked to the vibration modes of [C═C, C═O], and CH₃ molecules.

### Example 2. Synthesis of the Water-Based Paint Loaded with Silver (Ag) Nanoparticles

The antibacterial water-based paint composition according to the present invention contains: 7 to 12 percent by weight of titanium dioxide as white inorganic pigment, 25 to 35 percent by weight of filler which can be a type selected from the group consisting of talc or calcium carbonate, different masses of silver nanoparticles solution used as antibacterial additives, 30 to 40% by weight of an organic binder in the form of emulsion to bind the different elements of the water-based paint composition so as to form a smooth surface, and 15 to 20% by weight of water to mix the various materials of the paint. Among the other components, we utilized a thickening agent of 0.8 to 1%, a coalescing agent of 5 to 10% relative to the dry binder, a dispersion agent of 0.3 to 0.5 percent, and a silicone antifoaming agent of 0.15 to 0.3%. A tiny quantity of neutralizing agent to achieve a pH of 7.5 to 8. The final concentration of the silver (Ag) nanoparticles is about 500-2500 ppm, the preferred concentration is about 800 ppm.

### Example 3. Antibacterial Activities of Water-Based Paint Functionalized with Ag-PVA Nanoparticles

The culture medium has been designed to facilitate the inhibition of microorganism growth by diffusion. The following pathogens were tested for growth suppression in Luria-Bertani Agar—LB culture media (1 percent Bactotryptone, 0.5 percent yeast extract, 0.5 percent NaCl): Staphylococcus aureus, Escherichia coli, Pseudomonas aeruginosa, Acinetobacter, Citrobacter, and Enterobacter (Microorganism growth inhibition tests were performed in Luria-Bertani Agar—LB culture media (1 percent Bactotryptone, 0.5 percent yeast extract, 0.5 percent NaCl) using the following pathogens: Staphylococcus aureus, Escherichia coli, Pseudomonas aeruginosa, Acinetobacter, Citrobacter, and Enterobacter.) All of these experiments were repeated three times.

| | Zone of inhibition (mm) | | | | | |
|---|---|---|---|---|---|---|
| | Staphylococcus | Escherichia | Pseudomonas | | | |
| Compound | aureus | coli | aeruginosa | Acinetobacter | Citrobacter, | Enterobacter |
| AGPA | 11 | 10 | 13 | 13 | 12 | 8 |

### *Analysis of the Antibacterial Activities of Ag-PVA

The Agar Well Diffusion (AWD) technique was used to screen for the inhibitory impact of Ag nanoparticles and water-based paint coated with Ag-PVA nanoparticles Ag-PVA nanoparticles were placed in the area to be inhibited. After 20 hours of petri dish incubation at 37° C., the zones of inhibition were measured in millimeters under reflected light. Deep growth inhibition tests using Luria-Bertani Agar—LB were done to assess potential interferences from enriched culture media. The 5 mm diameter holes were aseptically filled with 50 L of Ag NPs (Table 2). Using the Agar Well Diffusion (AWD) method, all nanoparticles were tested for antibacterial efficacy against pathogens. To demonstrate the antibacterial properties of silver nanoparticles, an investigation of their antibacterial impact was performed. The antibacterial impact of Ag nanoparticles has been enhanced, and the attack surfaces against all bacteria have been increased, thus proving that these metallic nanoparticles have eliminated these bacteria and contribute to antibacterial activity. Table 2 highlights the diameters of the zones of inhibition produced by Ag nanoparticles for each of the bacteria tested (Staphylococcus aureus, Escherichia coli, Pseudomonas aeruginosa, Acinetobacter, Citrobacter and Enterobacter). After antibacterial activities, the diameters of the holes are raised to 11, 10, 13, 13, 12 and 8 mm for the bacteria Staphylococcus aureus, Escherichia coli, Pseudomonas aeruginosa, Acinetobacter, Citrobacter, and Enterobacter respectively.

### Table 2. Growth Inhibition by Diffusion of the Ag-PVA (AGPA) Nanoparticle Solution Against Pathogenic Strains

*Analysis of the Antibacterial Activities of Water-Based Paint Films Charged with Ag-PVA

In order to reveal the antibacterial impact of the water-based paint loaded with Ag nanoparticles, the same experiments were performed using the same technique of the agar well diffusion method (AWD) as screening for the inhibitory effect (already used for Ag nanoparticles alone). To do this, films of these paints containing Ag nanoparticles were spread out and dried before being inserted into petri dishes. The petri dishes were then incubated for 20 hours at a temperature of 37° C. Under reflected light, the zones of inhibition were measured in millimeters. To examine potential interferences from enriched culture medium, deep growth inhibition tests were performed using Luria-Bertani Agar—LB. Films with size of 5×5 mm² were placed aseptically. All films were screened for antibacterial activity against pathogens using the Agar Well Diffusion (AWD) method. To demonstrate their character, the analysis of the antibacterial effect of water-based paint films coated with Ag nanoparticles was carried out. The antibacterial impact of the Ag nanoparticle-loaded films has been enhanced, and the attack surfaces against all bacteria have been increased, thus demonstrating that these films have eliminated these bacteria and contribute to antibacterial activity. Table 3 summarizes the diameters of the zones of inhibition produced by Ag nanoparticles and water-based paint films coated with Ag nanoparticles for all bacteria tested (Staphylococcus aureus, Escherichia coli, Pseudomonas aeruginosa, Acinetobacter, Citrobacter, and Enterobacter) based on their size. After antibacterial activities, the sizes of the films are extended to 9, 8, 8, 13, 8 and 9 mm for the bacteria Staphylococcus aureus, Escherichia coli, Pseudomonas aeruginosa, Acinetobacter, Citrobacter, and Enterobacte respectively.

Ag nanoparticle-loaded films exhibit a reduction in attack surface sizes against all pathogenic bacteria. This amazing discovery is due to the fact that the surface of the paint alone does not contribute to the antibacterial activity, but that the metallic nanoparticles do.

TABLE 3
Growth inhibition by diffusion of Ag-PVA (AGPA) nanoparticle solution and
paint film functionalized with Ag nanoparticles against pathogenic strains
Example of an Embodiment

| | Inhibition zone (mm) | | | | | |
|---|---|---|---|---|---|---|
| | Staphylococcus | Escherichia | Pseudomonas | | | |
| Compound | aureus | coli | aeruginosa | Acinetobacter | Citrobacter, | Enterobacter |
| AGPA | 11 | 10 | 13 | 13 | 12 | 8 |
| Paint based | 9 | 8 | 8 | 13 | 8 | 9 |
| film with | | | | | | |
| Ag | | | | | | |

*Development and manufacturing of antibacterial water-based paint functionalized with metallic nanoparticles for antibacterial activity against nosocomial infections.
*Metallic silver nanoparticles are generated via the aqueous method under the following optimal conditions:

Mass of polyvinyl alcohol: 0.5 g
Volume of hot demineralized water: 25 ml
Silver concentration: (8 mM, 250 ml)
Heating temperature: 90° C.
Heating time: 2 hours
Cooling temperature: 20-25° C.

* A water-based paint loaded with metallic Ag nanoparticles according to the following optimal conditions:
Titanium dioxide weight: 7-12%
Filler weight: 25-35%
Weight of emulsion binder: 30-40%
Water weight: 15-20%
Dispersing agent weight: 0.3-0.5%
Weight of silicone defoamer: 0.15-0.3%
pH value: 7.5-8

*The morphological, optical, and spectroscopic properties of Ag nanoparticles are as follows:
Sizes of Ag nanoparticles: 83.27 nm
Ag nanoparticle morphology: Triangular
Absorption band: 430 nm
Molecular vibration band of Ag: 520 cm⁻¹

* The antibacterial properties of Ag nanoparticles against pathogenic strains are described by the diameters of the holes as follows:
Activity against the Staphylococcus aureus strain: diameter=11 mm
Activity against the Escherichia coli strain: diameter=10 mm
Activity against the Pseudomonas aeruginosa strain: diameter=13 mm
Activity against the Acinetobacter strain: diameter=13 mm
Activity against Citrobacter strain: diameter=12 mm
Activity against the Enterobacter strain: diameter=8 mm

* The antibacterial properties of the water-based paint coated with AG nanoparticles against pathogenic strains are described by the diameters of the holes as follows:
Activity against the Staphylococcus aureus strain: diameter-9 mm
Activity against the Escherichia coli strain: diameter=8 mm
Activity against the Pseudomonas aeruginosa strain: diameter=8 mm
Activity against the Acinetobacter strain: diameter=13 mm
Activity against Citrobacter strain: diameter=8 mm
Activity against the Enterobacter strain: diameter=9 mm

Advantageously, the invention intends to promote, profitably, and efficiently develop the industries of water-based paints by the insertion of additives based on metallic silver (Ag) nanoparticles. This invention will be used in hospital buildings by effectively attacking germs and pathogenic strains during medical treatments. This paint has considerable and effective antibacterial action against nosocomial diseases, which confirms its usage on wall supports in hospital buildings, namely public hospitals, private clinics, and all other care spaces. This invention falls within the scope of improving the antibacterial (antimicrobial) property of wall paints, with envisages their use as an alternative in healthcare establishments. More precisely, the invention pertains to the field of technology and the implementation of a mature technology that is accessible to wall paint producers and investors.

1. An aqueous silver nanoparticle composition, comprising silver nanoparticles sizes of 50-110 nm, polyvinyl alcohol, and water.

2. The aqueous silver nanoparticle composition of claim 1, characterized by that the silver nanoparticle having a UV-visible absorption peak at about 430 nm.

3. The aqueous silver nanoparticle composition of claims 1 and 2, characterized by that the silver nanoparticle is produced by mixing and heating ionic silver (Ag⁺) stock solution with a polyvinyl alcohol stock solution.

4. The aqueous silver nanoparticle composition of claims 1-3, wherein the ionic silver (Ag⁺) is silver nitrate.

5. The aqueous silver nanoparticle composition of claims 1-4, wherein the silver nitrate stock solution at about 6-10 nM.

6. The aqueous silver nanoparticle composition of claims 1-5, wherein the polyvinyl alcohol having molecular weight of about 89-98 kDa.

7. The aqueous silver nanoparticle composition of claims 1-6, wherein the polyvinyl alcohol stock solution is a about 1-3.5%.

8. The aqueous silver nanoparticle composition of claims 1-7, wherein the heating is at about 70-120° C.

9. A method of making the aqueous silver nanoparticle composition of claims 1-7, characterized by the steps of:
a. preparing a clear stock polyvinyl alcohol solution in water;
b. preparing an ionic silver (Ag⁺) solution;
c. incorporating the ionic silver (Ag⁺) solution with the polyvinyl alcohol solution; and
d. heating the polyvinyl alcohol and ionic silver (Ag⁺) solution.

10. The method of making the aqueous silver nanoparticle composition of claim 9, wherein the ionic silver (Ag⁺) solution is silver nitrate.

11. The method of making the aqueous silver nanoparticle composition of claims 9-10, wherein the ionic silver (Ag⁺) solution is about 6-10 nM.

12. The method of making the aqueous silver nanoparticle composition of claims 9-11, wherein the polyvinyl alcohol having a molecular weight of 89-98 kDa.

13. The method of making the aqueous silver nanoparticle composition of claims 9-12, wherein the polyvinyl alcohol solution is about 1-3.5% w/v.

14. The method of making the aqueous silver nanoparticle composition of claims 9-13, wherein the heating is at about 70-120° C.

15. A water-based paint, comprising:
an aqueous silver nanoparticle composition according claims 1-8;
a titanium dioxide weight ranging between 7 and 12%;
a filler weight ranging between 25 and 35%;
an emulsion binder weight ranging between 30 and 40%;
water weight ranging between 15 and 20%;
a dispersing agent weight ranging between 0.3 and 0.5%; and
a pH value ranging between 7.5 and 8.

16. The water based paint of claim 15, wherein the aqueous silver nanoparticle composition is 500-2,500 ppm.

17. The water based paint of claims 15 and 16, further comprising a silicone antifoam agent weight ranging between 0.15 and 0.3%.
